(19) United States
(12) Patent Application Publication
(10) Pub. No.: US 2004/0096700 A1
(43) Pub. Date: May 20, 2004

(54) Magnetic sensor system

(76) Inventors: Peter Scmollngruber, Aidlingen (DE); Henrik Siegle, Leonberg (DE); Maik Rabe, Korntal (DE)

Correspondence Address: KENYON & KENYON, ONE BROADWAY, NEW YORK, NY, 10004, US

(21) Appl. No.: 10/640,150

(22) Filed: Aug. 13, 2003

(30) Foreign Application Priority Data
Aug. 13, 2002 (DE) 10236983.6-33

(51) Int. Cl. B32B 9/00

(52) U.S. Cl. 428/692

(57) ABSTRACT

A magnet sensor system includes at least one magnetic-field-sensitive sensor layer in an integrated multilayer system whose electrical resistance is modifiable as a function of an external magnetic field. At least one soft-magnetic detection layer and at least one hard-magnetic layer are provided for generating an auxiliary magnetic field, and at least one non-magnetic intermediate layer is positioned there, across which the at least one soft-magnetic detection layer is exchange-coupled to the at least one hard-magnetic layer.

### FIELD OF THE INVENTION

The present invention relates to a magnetic sensor system, especially for sensing the motion of automotive parts that are moved in linear or rotating fashion.

### BACKGROUND INFORMATION

Generally, so-called GMR sensors are used as magnetic-field-sensitive components (GMR=Giant Magneto Resistance), for example, as relatively robust sensors in determining the angle of rotation in motor vehicles. These GMR sensors are made of coupled multi-layer units having at least one soft-magnetic detection layer, whose relative resistance alterations, as a function of the external magnetic field, have a characteristic curve that moves around a zero field. For example, the curve runs in a roughly triangular and, in response to a relatively weak external magnetic field, relatively flat manner, so that these sensors in weak magnetic fields are often not sensitive enough. For example, GMR sensors of this type are described in the publication, “Magneto-Resistive and Inductive Sensors,” of the Fa. Semelab plc, Prelim 6/98.

In addition, it is known from German Patent Application No. 199 49 714 that sensors of this type are designed as so-called spin-valve layer systems. In this context, the soft-magnetic detection layer is separated from a magnetically harder layer by a non-magnetic intermediate layer. The non-magnetic intermediate layer here has a layer thickness such that only a slight magnetic coupling arises between the two magnetic layers across the non-magnetic intermediate layer. Thus, it is achieved that the direction of the magnetization of the soft-magnetic detection layer follows the already very small external magnetic field. The direction of the magnetization of the hard-magnetic layer is oriented and maintained by a so-called pinning layer, the pinning layer being configured as a so-called antiferromagnet.

In detecting the sensor signal, especially when used, for example, in automobile technology, it is often necessary to shift the working point using auxiliary magnetic fields in the layer array that are generated in different ways. Examples of quite well-known possibilities include field generations of this type from microscopic hard magnets that are separately mounted in the area of the magnetoresistive layers, as well as the use of current-carrying field coils.

By way of example, in unprepublished German Patent Application No. 101 28 135.8, a concept is described where a hard-magnetic layer is deposited in the vicinity of, i.e., specifically on and/or below, a magnetoresistive layer stack. This hard-magnetic layer, through its stray field, then couples predominantly to the magnetosensitive layers and, in this context, generates a so-called bias magnetic field, which acts like a magnetic field offset, so that it is possible to achieve an easily measurable and relatively substantial change in the actual measuring value, which is detected as a change in resistance in the layer system, even when there is only a weak variation of an external magnetic field that is superimposed on the internal magnetic field.

In addition, from German Patent Application No. 199 83 808, a magnetoresistive layer system is known where two magnetoresistive layers are separated by a non-magnetic intermediate layer acting as a spacer. Furthermore, between the two magnetoresistive layers, in addition to the spacer there is a hard magnet, which is configured here as a patterned block at the edge of the magnetoresistive pattern. In this context, two oppositely poled bias currents flow through the two individual elements, a differential signal being formed from these currents. The hard-magnetic poles, which are formed as a result, are magnetized in this context orthogonally to the layer stack.

### SUMMARY OF THE INVENTION

In one refinement of a magnet sensor system of the type described above, one starts out from at least one sensor layer that is sensitive to magnetic fields, the layer being situated in an integrated multilayer system whose electrical resistance may be modified as a function of an external magnetic field. In addition, at least one non-magnetic intermediate layer is provided in at least one soft-magnetic detection layer and at least one hard-magnetic layer for generating an auxiliary magnetic field.

Across this non-magnetic intermediate layer, the at least one soft-magnetic detection layer is exchange-coupled to the at least one hard-magnetic layer.

The essence of the present invention is, therefore, essentially to integrate one or more hard-magnetic so-called bias layers in a GMR sensor multilayer system, as mentioned above, and to exchange-couple an intermediate between the hard-magnetic layer and the adjacent soft-magnetic layers. In this context, the hard-magnetic layer may replace one or more soft-magnetic layers that are exchange-coupled in antiparallel fashion, or it is deposited within this exchange-coupled soft-magnetic layer.

It is possible, for example, to use a multilayer system, having up to approximately 20 bilayers and having a uniform current direction, it also being possible to generate a differential bridge signal using an appropriate micropatterning or an electronic interconnection.

On the basis of the proposed integration of the hard-magnetic bias layer, for setting the working point, in the multilayers of GMR sensors, a high rationalization potential is generated from the possibility of taking on the preparation and micropatterning process of known GMR sensors. The concept of the present invention, which provides for using very thin layers, results in lower material costs and improved magnetic properties of the hard-magnetic layers used. It overcomes the problems posed by a short circuit caused by the hard magnet or a sharp field dropoff across the magnetoresistive layer, or the use of thick, expensive hard magnets, such as in the known bias concepts. Therefore, the working point of the multilayer sensor may easily be set using the stray field of the hard-magnetic layers. In addition, the coercivity (coercive force) of the hard magnet generally increases, especially in thin layers.

The close proximity of the hard magnet to the adjacent soft-magnetic layers, rendered possible by the design of the present invention, and the correspondingly high auxiliary or bias field at the location of the soft-magnetic layers, that is not attainable in an insulated design between hard magnet and soft magnet, makes it possible for each hard-magnetic layer to have a very thin construction. Thus, by integrating the hard magnet in the GMR sensor element, as provided, it is possible to minimize the distance between the hard magnet and the soft magnet, which leads to a homogeneous magnetization of the soft-magnetic layers.

The design of the present invention is also extremely resistant to noise fields. In this context, the magnetoresistive layers situated above and below the hard magnet are coupled in an antiferromagnetic fashion across their non-magnetic intermediate layers located in nearest proximity to the hard magnet. Therefore, the resulting magnetoresistive effect is the sum of the magnetoresistive effects of the individual layers or individual layer packets.

Generally, there is no need for any micropatterning that deviates from the original GMR sensor element. The number of hard-magnetic intermediate layers may be freely chosen in a multilayer element, under the secondary condition of the antiparallel orientation of the magnetization of adjacent layers, and, therefore, the strength of the bias field and the homogeneity are variable.

According to a first embodiment, each of two soft-magnetic layers is advantageously coupled to one side of a hard-magnetic layer across an intermediate non-magnetic layer through an intermediate-layer exchange-coupling, the exchange-coupled hard-magnetic layer being situated between two soft-magnetic layers.

Alternatively, it is also possible to individually couple two soft-magnetic layers across an intermediate non-magnetic layer through an intermediate-layer exchange-coupling on two sides of a hard-magnetic layer, the exchange-coupled hard-magnetic layer being situated between two soft-magnetic layers. In this context, the hard-magnetic layer may replace one or more exchange-coupled soft-magnetic layers.

### BRIEF DESCRIPTION OF THE DRAWINGS

FIG. 1 shows a diagrammatic view of a first exemplary embodiment of a cutaway view of a multilayer design of a GMR sensor having two intermediate-layer exchange-coupled hard- and soft-magnetic layers.

FIG. 2 shows a second exemplary embodiment that, in a variation of FIG. 1, has two soft-magnetic layers.

FIG. 3 shows a third exemplary embodiment having a layer design that is modified in relation to that in FIG. 2.

### DETAILED DESCRIPTION

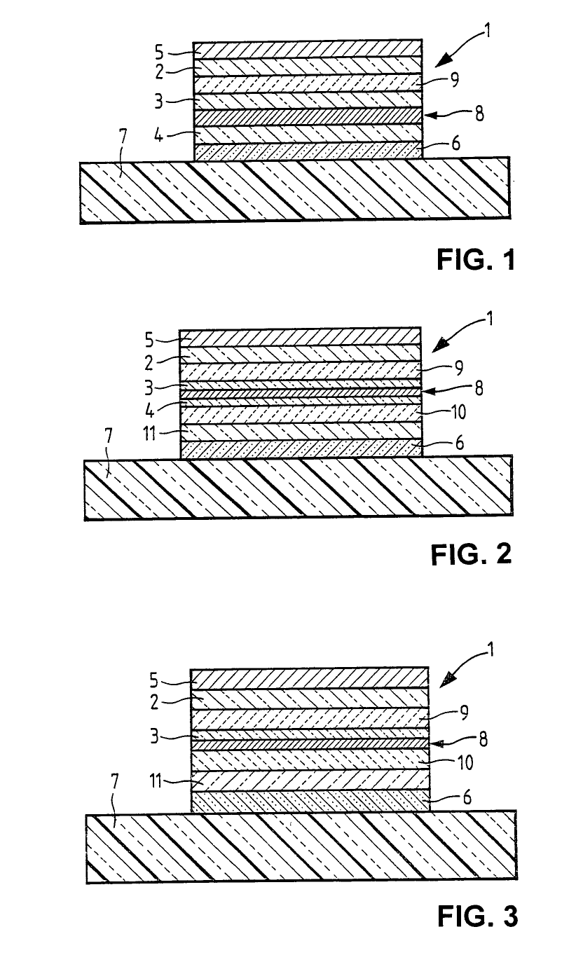

FIG. 1 shows a diagrammatic view of a GMR magnetic field sensor 1 which is fabricated in a multilayer construction. Soft-magnetic detection layers 2, 3, and 4 are provided for the actual magnetic field sensing mentioned above. Together with the other layers, referred to in greater detail below, this multilayer construction is deposited on a semiconductor substrate 7 between a cover layer 5, e.g., made of tantalum (Ta), and a buffer layer 6. The substrate material here may be a generally known silicon wafer, it being possible in principle to realize the present invention using other semiconductor substrate materials, such as so-called II-V semiconductors, SiC, Al₂O₃ or the like.

In the exemplary embodiment according to FIG. 1, a hard-magnetic layer 8, e.g., CoCrPt, CoSm, CoCr, CoCrTa, CoPt, FePt, etc., may be integrated in the GMR multilayer design as a so-called hard bias layer. In this context, two adjacent soft-magnetic layers 2 are exchange-coupled to hard magnet 8 across a non-magnetic intermediate layer 9.

From FIG. 2, a second exemplary embodiment of a GMR sensor can be seen, in which across a further non-magnetic intermediate layer 10 a further soft-magnetic layer 11 is exchange-coupled, which then, for its part, is magnetically pinned by integrated hard magnet 8.

In addition, a concept is also possible in accordance with FIG. 3, in which on one side of hard magnet 8, here the lower one, and on the other side of soft magnets 2, 3, in each case, the intermediate-layer exchange-coupling to the adjacent layer takes place. This intermediate-layer exchange-coupling is set by the thickness of non-magnetic intermediate layers 9, 10, such that individual, adjacent soft-magnetic layers 3, 11 are coupled in a magnetically antiparallel fashion.

The couplings of the layers of magnetic field sensor 1 cause the GMR effect described above. Additionally, in the context of the aforementioned exemplary embodiments of the present invention, a stray field of hard magnet 8 is produced, which couples the other soft-magnetic layers ferromagnetically and thus induces a preferential direction into sensor element 1. When an external field is applied, the stray field of hard magnet 8 is added, or in the other direction, the field of hard magnet 8 is subtracted from the applied field. In this manner, as described in the introductory part to the Specification, the shift of the sensor curve is brought about in a direction that is stipulated by the magnetization of hard magnet 8.

Therefore, in the depicted exemplary embodiments, there is no or only a slight reduction in the electrical resistance of the overall system of sensor 1 with respect to a known configuration of a sensor without a hard magnet. In alternative conceptions, in which a hard magnet is executed as an upper or lower layer, the layer thickness must then be selected so as to be appropriately large in order to generate a sufficient stray field, which accordingly magnetizes all the soft-magnetic layers.

The hard-magnet layer according to the exemplary embodiments is executed in the vicinity of the soft-magnetic layers, which leads to a homogeneous magnetization of the soft-magnetic layers. In this context, inserting hard-magnetic layer 8 into a soft-magnetic one in each case hardens the previously soft-magnetic layer, i.e., increases its coercivity. A high coercivity, as occurs above all in the thin layers described here, therefore hinders a commutation of the bias field, even in the case of correspondingly high noise fields. In addition, in response to the direct magnetic exchange-coupling of soft and hard magnets that are deposited on one another, the individual soft-magnetic layer strengthens the resulting stray field. The known method of manufacturing sensor elements of every configuration can be maintained, without requiring essential modifications to the processing.

What is claimed is:

1. A magnetic sensor system comprising:
at least one magnetic-field-sensitive sensor layer in an integrated multilayer system whose electrical resistance is modifable as a function of an external magnetic field;
at least one soft-magnetic detection layer and at least one hard-magnetic layer for generating an auxiliary magnetic field; and
at least one non-magnetic intermediate layer across which the at least one soft-magnetic detection layer is exchange-coupled to the at least one hard-magnetic layer.

2. The magnetic sensor system according to claim 1, wherein the at least one soft-magnetic layer includes a plurality of soft-magnetic layers, and wherein, in each case, two of the soft-magnetic layers are coupled across one of the at least one non-magnetic intermediate layer through an intermediate-layer exchange-coupling to one side of one of the at least one hard-magnetic layer, the hard-magnetic layer being situated between two of the soft-magnetic layers.

3. The magnetic sensor system according to claim 1, wherein the at least one soft-magnetic layers, and wherein, in each case, two of the soft-magnetic layers are coupled across one of the at least one non-magnetic intermediate layer through an intermediate-layer exchange-coupling to both sides of one of the at least one hard-magnetic layer, the hard-magnetic layer being situated between two of the soft-magnetic layers.

4. The magnetic sensor system according to claim 3, wherein the hard-magnetic layer replaces at least one of the soft-magnetic layers.

5. The magnetic sensor system according to claim 1, wherein the multi-layer system is situated on a substrate between a cover layer and a buffer layer.
